(19) United States
(12) Patent Application Publication
(10) Pub. No.: US 2026/0086609 A1
(43) Pub. Date: Mar. 26, 2026

(54) SUPPORT APPARATUS

(71) Applicant: Lenovo (Beijing) Limited, Beijing (CN)

(72) Inventors: Junwei CHEN, Beijing (CN); Enling PANG, Beijing (CN); Zhuoyuan LI, Beijing (CN)

(21) Appl. No.: 19/322,165

(22) Filed: Sep. 8, 2025

(30) Foreign Application Priority Data
Sep. 23, 2024 (CN) 202411328104.5

(51) Int. Cl. G06F 1/16

(52) U.S. Cl. CPC G06F 1/1681; G06F 1/1616; G06F 1/1654

(57) ABSTRACT

A support apparatus includes a first body, a second body, and a transmission mechanism. The first body has a first mass greater than a threshold. The second body is configured to carry an external electronic device. The transmission mechanism connects a first edge of the second body and the first body. Based on the transmission mechanism, the second body is rotatable relative to the first body. In response to the second body having a first angle relative to the first body, the transmission mechanism is in a first state, and in response to the second body having a second angle greater than the first angle relative to the first body, the transmission mechanism is in a second state. In response to the transmission mechanism being in the first state, a first reference point on the first edge and a center of gravity of the first body have a first distance.

### CROSS-REFERENCES TO RELATED APPLICATION

The present disclosure claims priority to Chinese Patent Application No. 202411328104.5 filed on Sep. 23, 2024, the entire content of which is incorporated herein by reference.

### FIELD OF TECHNOLOGY

The present disclosure relates to the support apparatus technology field and, more particularly, to a support apparatus configured to support an outer electronic device.

### BACKGROUND

A tablet product is often used with a keyboard to replace an application scenario of an existing laptop. In this application scenario, a certain support method is required to maintain a certain angle (generally)>120° between the tablet and a desk surface, and to prevent tipping over during application.

The existing laptop provides a support force mainly through a damping rotation shaft. However, this method is not applicable to the tablet product. The reason is that, for the existing laptop, most of the weight is distributed at the base where the keyboard is provided, and the weight of the display is light. Since the base is heavier, the laptop is not prone to tipping. In contrast, in the combination of a tablet and a keyboard, the tablet is heavier than the keyboard. Thus, the tablet is prone to tipping when tapping the screen.

### SUMMARY

One aspect of this disclosure provides a support apparatus, including a first body, a second body, and a transmission mechanism. The first body has a first mass greater than a threshold. The second body is configured to carry an external electronic device. The transmission mechanism connects a first edge of the second body and the first body. Based on the transmission mechanism, the second body is rotatable relative to the first body. In response to the second body having a first angle relative to the first body, the transmission mechanism is in a first state, and in response to the second body having a second angle greater than the first angle relative to the first body, the transmission mechanism is in a second state. In response to the transmission mechanism being in the first state, a first reference point on the first edge and a center of gravity of the first body have a first distance, in response to the transmission mechanism being in the second state, the first reference point on the first edge and the center of gravity of the first body have a second distance, and the first distance is greater than the second distance.

### BRIEF DESCRIPTION OF THE DRAWINGS

In combination with accompanying drawings and with reference to the following description of embodiments, the above and other features, advantages, and aspects of the embodiments of the present disclosure will become more apparent. Throughout the drawings, a same or similar reference number represents a same or similar element. It should be understood that the drawings are schematic and that an element is not necessarily drawn to scale.

FIG. 1 is a schematic perspective diagram of a support apparatus in a status according to some embodiments of the present disclosure.

FIG. 2 is a schematic perspective diagram of a support apparatus in another status according to some embodiments of the present disclosure.

FIG. 3 is a schematic side view of a support apparatus in a status according to some embodiments of the present disclosure.

FIG. 4 is a schematic side view of a support apparatus in another status according to some embodiments of the present disclosure.

FIG. 5 is a schematic perspective diagram of a support apparatus in another status according to some embodiments of the present disclosure.

FIG. 6 is a schematic local enlarged diagram of member A of the support apparatus of FIG. 5.

FIG. 7 is a schematic side view of the support apparatus of FIG. 5 in a status.

FIG. 8 is a schematic side view of the support apparatus of FIG. 5 in another status.

FIG. 9 is a schematic local exploded diagram of a support apparatus according to some embodiments of the present disclosure.

FIG. 10 is a schematic local enlarged diagram of member B of the support apparatus of FIG. 9.

FIG. 11 is a schematic local enlarged diagram of member C of the support apparatus of FIG. 9.

FIG. 12 is a schematic perspective diagram of a first rotation shaft according to some embodiments of the present disclosure.

FIG. 13 is a schematic perspective diagram of a first direction change gear sleeve according to some embodiments of the present disclosure.

FIG. 14 is a schematic perspective diagram of a first position-limiting unit according to some embodiments of the present disclosure.

FIG. 15 is a schematic perspective diagram showing a first view angle of a first bracket according to some embodiments of the present disclosure.

FIG. 16 is a schematic perspective diagram showing a second view angle of a first bracket according to some embodiments of the present disclosure.

FIG. 17 is a schematic perspective diagram of a second position-limiting unit according to some embodiments of the present disclosure.

FIG. 18 is a schematic perspective diagram of a second bracket according to some embodiments of the present disclosure.

FIG. 19 is a schematic perspective diagram of a shell according to some embodiments of the present disclosure.

FIG. 20 is a schematic perspective diagram showing a status of an electronic device mounted at a support apparatus according to some embodiments of the present disclosure.

FIG. 21 is a schematic perspective diagram of another status of an electronic device mounted at a support apparatus according to some embodiments of the present disclosure.

### REFERENCE NUMERALS

| | | |
|---|---|---|
| 1 First body | 2 Second body | 21 Mounting member |
| 3 Transmission mechanism | 31 First rotation shaft | 311 First gear sleeve |
| 32 Support assembly | 321 First bracket | 3211 Blocking arm |
| 3212 Extension member | 3213 Groove | 322 Second bracket |
| 323 Mounting hole | 324 First position-limiting unit | 3241 Through-hole |
| 3242 Protrusion | 325 Second position-limiting unit | 3251 Blocking protrusion |
| 33 Second rotation shaft | 331 Second gear sleeve | 34 Reversing assembly |
| 341 Reversing shaft | 342 Gear sleeve assembly | |
| 3421 First reversing gear sleeve | 3422 Second reversing gear sleeve | |
| 35 Damping assembly | 351 Elastic ring | 352 Locking part |
| 36 Shell body | 361 End cover | 362 Body member |
| 363 Fixing part | 4 Display device | 5 First body |
| 12 Input apparatus | | |

### DETAILED DESCRIPTION

The purpose, technical solutions, and advantages of embodiments of the present disclosure are described in detail in connection with the accompanying drawings and embodiments of the present disclosure. The present disclosure is further described in detail according to the accompanying drawings.

The terms used here are merely for describing particular embodiments and are not intended to limit the present disclosure. The terms “comprise” and “include” used here indicate the presence of the described features, steps, operations, and/or components, but do not preclude the presence or addition of one or more other features, steps, operations, or components.

All terms used here, including technical and scientific terms, have the meanings commonly understood by those skilled in the art, unless otherwise defined. The terms used here should be interpreted as having meanings consistent with the context of this specification and should not be interpreted in an idealized or overly rigid manner.

“At least one of A, B, and C” should generally be interpreted according to the meaning commonly understood by those skilled in the art. For example, “a system including at least one of A, B, or C” should include but not be limited to a system having A only, B only, C only, A and B, A and C, B and C, and/or A, B, and C. When an expression is similar to “at least one of A, B, or C,” “at least one of A, B, or C” should generally be interpreted according to the meaning commonly understood by those skilled in the art. For example, “a system having at least one of A, B, or C” should include but not be limited to a system having A only, B only, C only, A and B, A and C, B and C, and/or A, B, and C.

Directional terms mentioned in embodiments of the present disclosure, such as “up,” “down,” “front,” “rear,” “left,” “right,” etc., are merely directions with reference to the accompanying drawings and are not intended to limit the scope of the present disclosure. Throughout the accompanying drawings, identical elements can be indicated by the same or similar reference numerals. Conventional structures or configurations can be omitted when confusion is caused in understanding the present disclosure.

To prevent the above-mentioned device from tipping over during operation, one approach in the related art is to provide a support apparatus at a back panel of an electronic device. This solution can be simple and satisfy a wide angle range. However, this solution requires two separate opening actions during application, one opening action to open the back panel and another opening action to open a keyboard, which are cumbersome. Another approach can include providing dual rotation shafts. That is, another rotation shaft can be provided on the back panel, which does not require additional components, and the operation is simple. However, the two sets of rotation shafts may need a certain distance, and a large-sized back panel is needed. Another approach can include providing a large size of keyboard to extend the keyboard outwardly at the portion where the keyboard is connected to the display device and protrude from the display device. This solution is simple with high reliability. However, for a light keyboard, protrusion portion may need to be large, which increases the size of the keyboard.

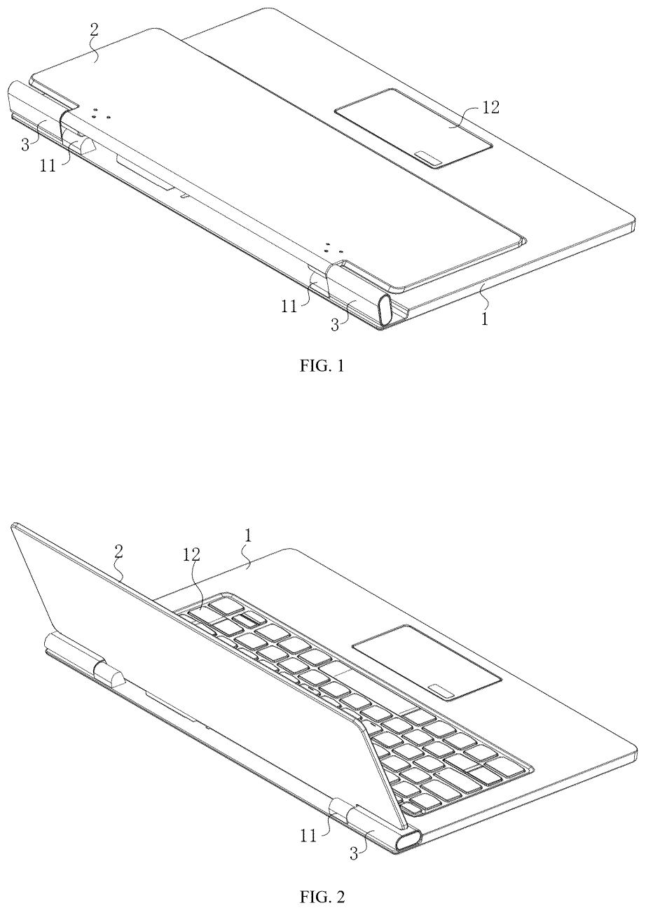

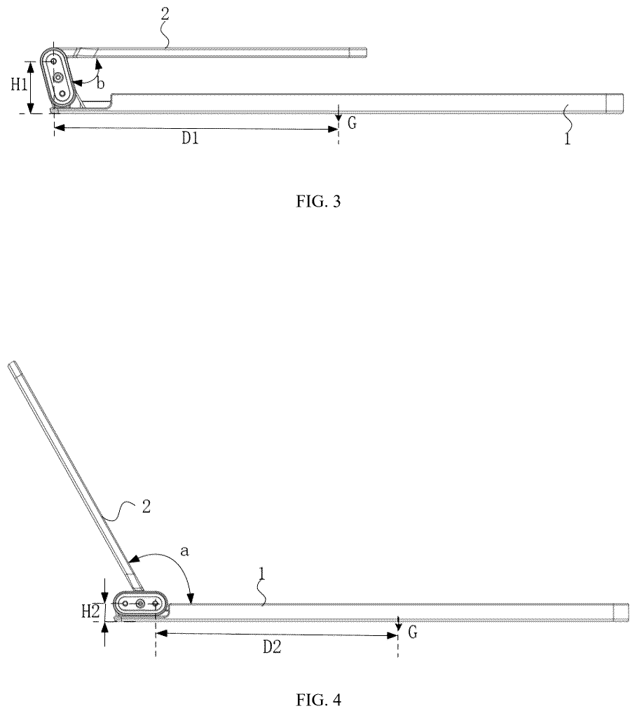

FIG. 1 is a schematic perspective diagram of a support apparatus in a status according to some embodiments of the present disclosure. FIG. 2 is a schematic perspective diagram of a support apparatus in another status according to some embodiments of the present disclosure. FIG. 3 is a schematic side view of a support apparatus in a status according to some embodiments of the present disclosure. FIG. 4 is a schematic side view of a support apparatus in another status according to some embodiments of the present disclosure.

Embodiments of the present disclosure provide a support apparatus. As shown in FIGS. 1 to 4, the support apparatus includes a first body 1, a second body 2, and a transmission mechanism 3. The first body 1 includes a first mass greater than a threshold. The second body 2 can be configured to carry an external electronic device 4. The transmission mechanism 3 connects a first edge of the second body 2 and the first body 1. Based on the transmission mechanism 3, the second body 2 can rotate relative to the first body 1, or the first body 1 can rotate relative to the second body 2. When the second body 2 has a first angle relative to the first body 1, the transmission mechanism 3 can be in a first state. When the second body 2 has a second angle greater than the first angle relative to the first body 1, the transmission mechanism 3 can be in a second state. When the transmission mechanism 3 is in the first state, a first reference point (e.g., a center point) on the first edge and the center of gravity G of the first body 1 have a first distance (e.g., D1 in FIG. 3). When the transmission mechanism 3 is in the second state, the first reference point on the first edge and the center of gravity of the first body 1 have a second distance (e.g., D2 in FIG. 3). The first distance D1 is greater than the second distance D2.

According to the support apparatus of the present disclosure, the transmission mechanism 3 can be arranged between the first body 1 and the second body 2. The second body 2 can rotate relative to the first body 1 based on the transmission mechanism 3. When the transmission mechanism 3 is in the first state, the first reference point (e.g., the center point) on the first edge and the center of gravity of the first body 1 can have the relatively large first distance D1. When the transmission mechanism 3 is in the second state, the first reference point on the first edge and the center of gravity of the first body 1 can have the relatively small second distance D2. The transmission mechanism 3 can allow the first edge of the second body 2 to move forward relative to the center of gravity of the second body 2 when the transmission mechanism 3 is in the second state. Thus, when the whole support apparatus is subjected to an external force (e.g., a tapping operation on the electronic device 4), a tipping moment can be reduced to improve the stability of the support apparatus.

For example, the first angle can be 0° or 10°, and the second angle may be any one of 90°, 120°, 150°, or 160°.

To ensure that the electronic device does not tip over during application, a lever balance condition may need to be satisfied, i.e.:

$$F \times L + G 2 \times L 2 \leq G 1 \times L 1 \qquad ( 1 )$$

where, F represents an external force applied to the electronic device (e.g., a clicking operation), L represents the distance from the external force applied to the electronic device to the support point, G2 represents the second mass of the electronic device and the second body, L2 represents the distance from the center of gravity of the electronic device and the second body to the support point, G1 represents the first mass, and L1 represents the distance from the center of gravity of the first body to the support point.

The support apparatus of embodiments of the present disclosure can enable the first body 1 to rotate relative to the second body 2 based on the transmission mechanism 3. When the transmission mechanism 3 is in the first state, the first reference point (e.g., the center point) on the first edge and the center of gravity of the first body 1 can have the large first distance D1. When the transmission mechanism 3 is in the second state, the first reference point on the first edge and the center of gravity of the first body 1 can have the small second distance D2, which is equivalent to reducing the distance L2 in equation (1) to make the support apparatus more stable.

In some embodiments, as shown in FIG. 2, an input apparatus 12 is arranged on the first body 1. The input apparatus 12 can be configured to perform an input operation on the electronic device 4 arranged on the second body 2. The input apparatus 12 can be integrally formed with the first body 1 (e.g., integrating the input apparatus 12 into the first body 1), or can be separately formed from the first body 1 (e.g., an independent input apparatus being arranged on the first body 1).

In some embodiments, the input apparatus 12 can include one or more of a keyboard, a touchscreen, and a touchpad.

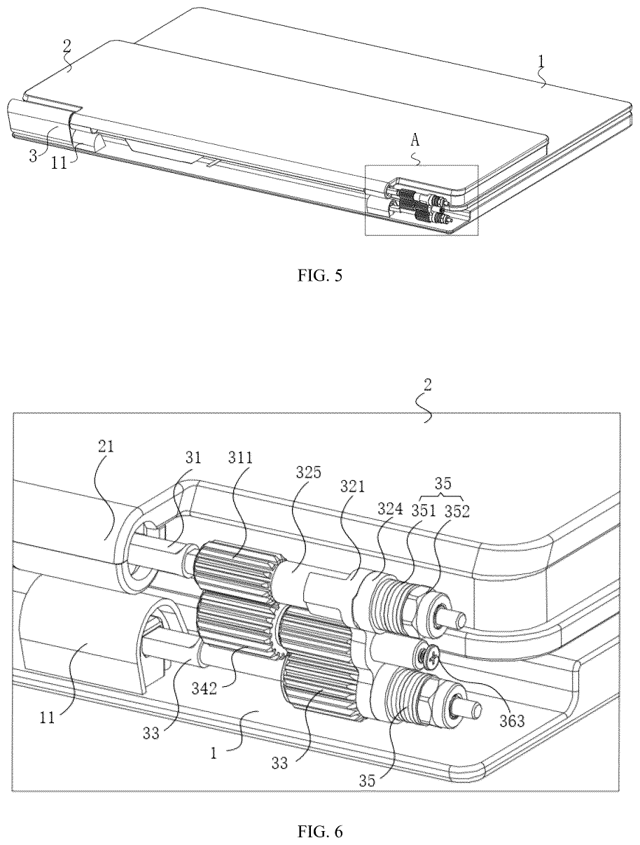

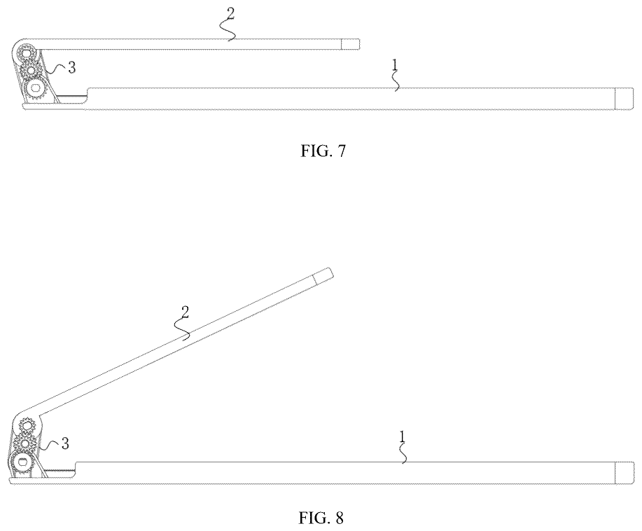

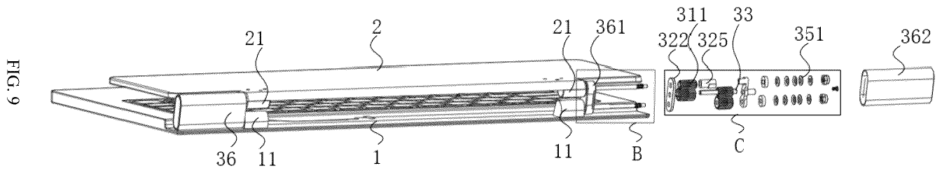

FIG. 5 is a schematic perspective diagram of a support apparatus in another status according to some embodiments of the present disclosure. FIG. 6 is a schematic local enlarged diagram of member A of the support apparatus of FIG. 5. FIG. 7 is a schematic side view of the support apparatus of FIG. 5 in a status. FIG. 8 is a schematic side view of the support apparatus of FIG. 5 in another status.

In embodiments of the present disclosure, as shown in FIGS. 5 to 8, the transmission mechanism 3 includes a rotation shaft (e.g., a first rotation shaft 31 connected to the first body 1, or a reversing shaft 341 arranged between the first rotation shaft 31 and the second rotation shaft 33, which are described below). When the transmission mechanism 3 is in the first state, the rotation shaft can be in a first position state. When the transmission mechanism 3 is in the second state, the rotation shaft can have a second position state. In the first position state, the rotation shaft can have a third distance to the plane on where the first body 1 is located (e.g., H1 in FIG. 3). In the second position state, the rotation shaft can have a fourth distance to the plane where the first body 1 is located (e.g., H2 in FIG. 4). The fourth distance H2 is smaller than the third distance H1.

In some embodiments, when the transmission mechanism 3 moves from the first state to the second state, the rotation shaft can move in the direction toward the plane where the first body 1 is located (e.g., a placement surface). Thus, the distance between the center of gravity G of the second body 2 and the rotation shaft can be reduced, which is equivalent to reducing L2 in equation (1) to help prevent the electronic device 4 from tipping over during application.

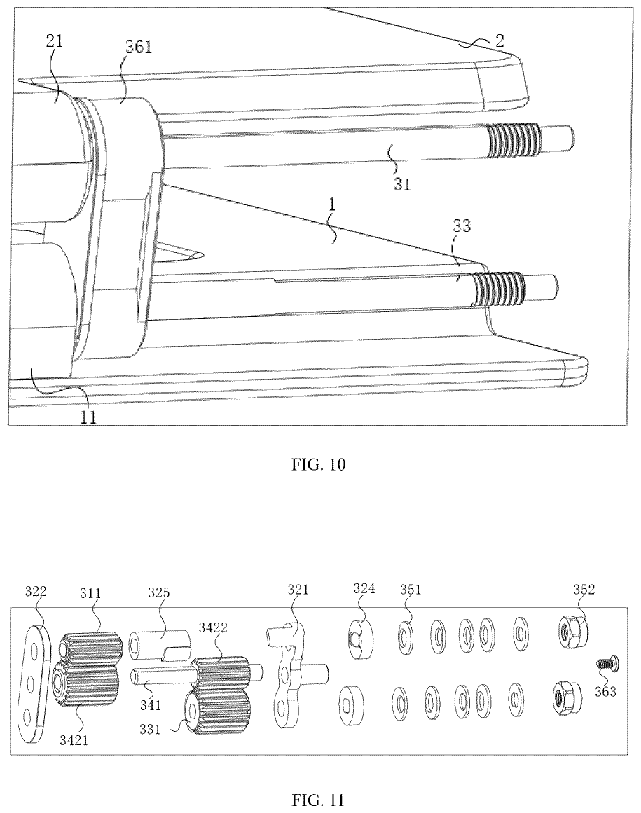

FIG. 9 is a schematic local exploded diagram of a support apparatus according to some embodiments of the present disclosure. FIG. 10 is a schematic local enlarged diagram of member B of the support apparatus of FIG. 9.

In embodiments of the present disclosure, as shown in FIGS. 6, 9, and 10, the transmission mechanism 3 includes the first rotation shaft 31 and the second rotation shaft 33. The first axis of the first rotation shaft 31 is parallel to the second axis of the second rotation shaft 33. The second body 2 can perform first rotation (e.g., self-rotation) around the first axis in the first direction relative to the transmission mechanism 3 to cause the second body 2 to perform second rotation (e.g., revolution) with the transmission mechanism 3 around the second axis in the second direction opposite to the first direction relative to the first body. Thus, the transmission mechanism 3 can move from the first state to the second state or from the second state to the first state.

In some embodiments, while the second body 2 rotates clockwise about the first axis, the transmission mechanism 3 can rotate counterclockwise about the second axis. Alternatively, while the second body 2 rotates counterclockwise about the first axis, the transmission mechanism 3 can rotate clockwise about the second axis.

In some embodiments, the first rotation shaft 31 and the second rotation shaft 33 can be arranged in parallel. The second body 2 can be mounted on the first rotation shaft 31. The first body 1 can be mounted on the second rotation shaft 33. While an external force drives the second body 2 to self-rotate about the first axis in the first direction relative to the transmission mechanism 3, the second body 2 can revolve around the second axis with the transmission mechanism 3 in the second direction opposite the first direction relative to the first body 1. Thus, after the second body 2 rotates to a certain operation angle relative to the first body 1, the center of gravity of the second body 2 can move forward relative to the first edge of the first body, which reduces the tipping over moment to prevent the support apparatus from tipping over.

In some embodiments, as shown in FIGS. 1, 2, 5, and 6, a shaft base 11 is arranged on the first body 1, and one end of the second rotation shaft 33 extends into the shaft base 11 to cause the second rotation shaft 33 to be stationary relative to the shaft seat 11. A mounting base 21 is arranged on the first edge of the second body 2, and one end of the second rotation shaft 33 can extend into the mounting base 21 to cause the second rotation shaft 33 to rotate with the second body 2 and be stationary relative to the mounting base 21.

FIG. 11 is a schematic local enlarged diagram of member C of the support apparatus of FIG. 9.

In embodiments of the present disclosure, as shown in FIGS. 6, 9, and 11, the transmission mechanism 3 further includes a support assembly 32 and a reversing assembly 34. The support assembly 32 is suitable to be rotatably mounted between the first rotation shaft 31 and the second rotation shaft 33. The reversing assembly 34 is rotatably mounted on the support assembly 32. The reversing assembly 34 is configured to convert the first rotation of the first rotation shaft 31 around the first axis in the first direction relative to the support assembly 32 into the second rotation of the second body 2 around the second axis with the support assembly 32 in the second direction relative to the first body 1.

In some embodiments, the first rotation shaft 31 and the second rotation shaft 33 can rotate relative to the support assembly 32 and cooperate with the reversing assembly through the support assembly to convert the self-rotation of the first body 1 around the first axis in the first direction relative to the transmission mechanism 3 into the revolution of the second body 2 around the second axis in the second direction relative to the first body 1.

In some embodiments, through the cooperation between the support assembly 32 and the reversing assembly 34, the self-rotation of the first body 1 around the first axis in the first direction can be converted into the revolution of the second body 2 around the second axis with the support assembly 32 in the second direction. Thus, the opening operation can be simplified and simple, and the support can be stable.

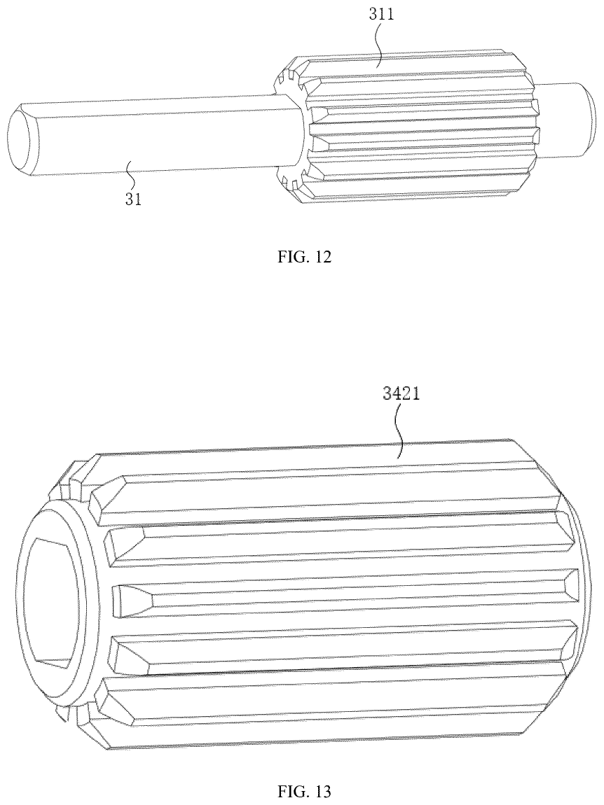

FIG. 12 is a schematic perspective diagram of a first rotation shaft according to some embodiments of the present disclosure.

In embodiments of the present disclosure, as shown in FIGS. 6, 11, and 12, the first rotation shaft 31 is provided with a first gear sleeve 311, and the second rotation shaft 33 is provided with a second gear sleeve 331. The reversing assembly 34 includes a reversing shaft 341 and a gear sleeve group 342. The reversing shaft 341 is mounted in parallel between the first rotation shaft 31 and the second rotation shaft 33 through the support assembly 32. The gear sleeve group 342 is arranged on the reversing shaft 341 and meshed with the first gear sleeve 311 and the second gear sleeve 331 to convert the first rotation into the second rotation.

In some embodiments, the first gear sleeve 311 can be stationary relative to the first rotation shaft 31. The second gear sleeve 331 can be stationary relative to the second rotation shaft 33. The gear sleeve group 342 can be stationary relative to the reversing shaft 341.

The first gear sleeve 311 can be integrally or separately formed with the first rotation shaft 31. When the first gear sleeve 311 and the first rotation shaft 31 are separately formed, the cross-section of at least the first mounting section of the first rotation shaft 31 for mounting the first gear sleeve 311 can be non-circular (e.g., D-shaped or rectangular). Thus, when the first mounting section passes through the first through-hole of the first gear sleeve 311, the first mounting section can cooperate with the through-hole to cause the first gear sleeve 311 to rotate with the first rotation shaft 31. The cross-section of the first through-hole can match the shape of the cross-section of the first mounting section.

Similarly, the second gear sleeve 331 can also be integrally or separately formed with the second rotation shaft 33, and the reversing gear sleeve can be integrally or separately formed with the reversing shaft 341.

FIG. 13 is a schematic perspective diagram of a first reversing gear sleeve according to some embodiments of the present disclosure.

In embodiments of the present disclosure, as shown in FIGS. 6, 11, and 13, the gear sleeve group 342 includes a first reversing gear sleeve 3421 and a second reversing gear sleeve 3422. The first reversing gear sleeve 3421 is meshed with the first gear sleeve 311, and the second reversing gear sleeve 3422 is meshed with the second gear sleeve 331 to convert the first rotation into the second rotation.

In some embodiments, as shown in FIG. 13, at least one of the first reversing gear sleeve 3421 and the second reversing gear sleeve 3422 is separately formed from the reversing shaft 341. When being separately formed from the reversing shaft 341, the mounting section of the reversing shaft 341 configured to mount the first reversing gear sleeve 3421 and the second reversing gear sleeve 3422 has a non-circular cross-section to match the mounting holes on the first reversing gear sleeve 3421 and the second reversing gear sleeve 3422. Thus, the first reversing gear sleeve 3421 and the second reversing gear sleeve 3422 can rotate simultaneously with the reversing shaft 341.

In embodiments of the present disclosure, the number of teeth of the first reversing gear sleeve 3421 can be greater than the number of teeth of the second reversing gear sleeve 3422, the number of teeth of the first reversing gear sleeve 3421 can be greater than the number of teeth of the first gear sleeve 311, and/or the number of teeth of the second gear sleeve 331 can be greater than the number of teeth of the second reversing gear sleeve 3422.

As shown in FIG. 4, the rotation angle of the second body 2 relative to the first body 1 is a, and the angle of the transmission mechanism 3 relative to the first body 1 is b. Then the rotation angle c of the second body 2 relative to the transmission mechanism 3 is:

$$c = a + b \qquad ( 2 )$$

To ensure the matching of the rotation angles, the number of teeth z1 of the first gear sleeve 311, the number of teeth z2 of the second gear sleeve 331, the number of teeth z3 of the first reversing gear sleeve 3421, the number of teeth z4 of the second reversing gear sleeve 3422, the rotation angle a of the second body 2 relative to the first body 1, and the rotation angle c of the second body 2 relative to the transmission mechanism 3 should satisfy:

$$m = \frac{z 1}{z 3} ; \qquad ( 3 )$$

$$n = \frac{z 4}{z 2} ; and \qquad ( 4 )$$

$$m \times n = \frac{b}{a + b} . \qquad ( 5 )$$

where m denotes a first transmission ratio between the first gear sleeve 311 and the first reversing gear sleeve 3421, and n denotes a second transmission ratio between the second gear sleeve 331 and the second reversing gear sleeve 3422.

According to formulas (3) and (4), the number of teeth z3 of the first reversing gear sleeve 3421 is greater than the number of teeth z4 of the second reversing gear sleeve 3422, which can reduce the difference between the number of teeth z1 of the first gear sleeve 311 and the number of teeth z2 of the second gear sleeve 331 to avoid an excessively large second gear sleeve 331 and reduce the volume and weight of the support apparatus.

In some embodiments, the number of teeth z3 of the first reversing gear sleeve 3421 can be greater than the number of teeth z1 of the first gear sleeve 311. Thus, the difference in number of teeth between the second reversing gear sleeve 3422 and the second gear sleeve 331 can be reduced.

In some embodiments, the number of teeth z2 of the second gear sleeve 331 can be greater than the number of teeth z4 of the second reversing gear sleeve 3422. Thus, the difference in number of teeth between the first gear sleeve 311 and the first reversing gear sleeve 3421 can be reduced.

In embodiments of the present disclosure, as shown in FIGS. 6 and 11, the support assembly 32 includes two brackets arranged in a direction parallel to the first axis at an interval. The two brackets include a first bracket 321 and a second bracket 322. Mounting holes are formed on each bracket at intervals in a direction perpendicular to the first axis. The first rotation shaft 31, the second rotation shaft 33, and the reversing shaft 341 pass through the mounting holes and are mounted on the two brackets.

In embodiments of the present disclosure, as shown in FIGS. 6 and 11, the transmission mechanism 3 further includes a damping assembly 35. The damping assembly 35 is arranged on at least one of the first rotation shaft 31 and the second rotation shaft 33, and is configured to cooperate with the support assembly 32 to constrain the second body 2 in a target posture.

In some embodiments, the damping assembly 35 includes a first damping unit and a second damping unit. The first damping unit is arranged on the first rotation shaft 31, and the second damping unit is arranged on the second rotation shaft 33. The second damping unit is configured to cooperate with the first damping unit and the support assembly 32 to maintain the second body 2 in the target posture.

In some embodiments, as shown in FIGS. 6, 9, and 11, at least one of the first damping unit and the second damping unit includes a plurality of elastic rings 351 arranged adjacently and a locking member 352. The elastic rings 351 and the support assembly 32 are sleeved on at least one of the first rotation shaft 31 and the second rotation shaft 33 next to each other. The locking member 352 and the plurality of elastic rings 351 are sleeved on at least one of the first rotation shaft 31 and the second rotation shaft 33 next to each other. The locking member 352 can be configured to cooperate with the support assembly 32 to apply pressure to the plurality of elastic rings 351 to compress the plurality of elastic rings 351 against each other. Thus, sufficient friction can be generated between the elastic rings 351 to increase the friction between the elastic ring 351 and at least one of the first rotation shaft 31 and the second rotation shaft 33 to restrict the posture of the second body 2.

In some embodiments, the elastic rings 351 can be made of a material with a high friction coefficient, such as rubber, leather, composite materials, or other special friction materials.

In some embodiments, external threads can be formed on the surfaces of the first rotation shaft 31 and the second rotation shaft 33 and at least configured to mount the locking member 352. The locking member 352 can be a nut threaded to the external thread. Further, the locking member 352 can be a locking nut.

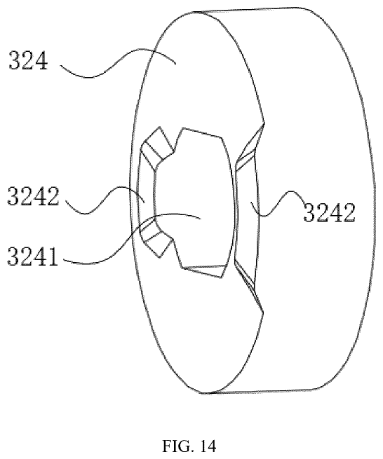

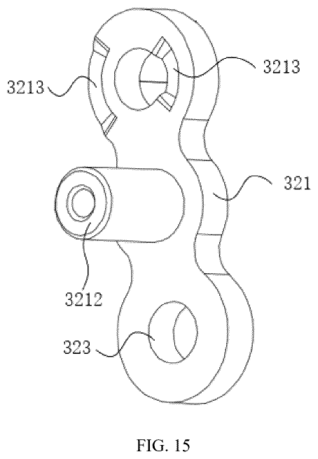

FIG. 14 is a schematic perspective diagram of a first position-limiting unit according to some embodiments of the present disclosure.

In embodiments of the present disclosure, as shown in FIG. 6, FIG. 11, and FIG. 14, the support assembly 32 further includes a first position-limiting unit 324. The first position-limiting unit 324 is mounted on the first rotation shaft 31 and is adjacent to the first bracket 321 of the two brackets. The first position-limiting unit 324 is configured to cooperate with the first bracket 321 through a snap connection when the mounting surface of the second body 2 is parallel to the upper surface of the first body 1 to constrain the second body 2 at the target position.

In some embodiments, as shown in FIG. 14, a through-hole 3241 is formed on the first position-limiting unit 324, and the shape of the through-hole 3241 is non-circular. The cross-sectional shape of the second mounting section of the first rotation shaft 31 for mounting the first position-limiting unit 324 matches the shape of the through-hole 3241, so that the first position-limiting unit 324 rotates with the first rotation shaft 31. The second mounting section can be connected to the first mounting section.

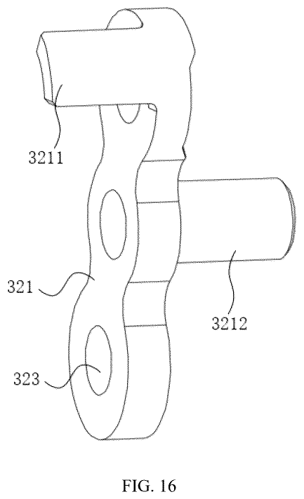

FIG. 15 is a schematic perspective diagram showing a first view angle of a first bracket according to some embodiments of the present disclosure. FIG. 16 is a schematic perspective diagram showing a second view angle of a first bracket according to some embodiments of the present disclosure.

In some embodiments, as shown in FIG. 15 and FIG. 16, a plurality of mounting holes 323 are formed on the first bracket to mount the first rotation shaft 31, the second rotation shaft 33, and the reversing shaft 341, and allow the first rotation shaft 31, the second rotation shaft 33, and the reversing shaft 341 to rotate within the plurality of mounting holes 323.

In some embodiments, as shown in FIG. 6 and FIG. 14, at least one protrusion 3242 is formed by extending a surface of the side of the first position-limiting unit 324 facing the first bracket 321 in the direction toward the first bracket 321 along the first axial direction.

As shown in FIG. 15, the surface of the first bracket 321 on the side facing the first position-limiting unit 324 is recessed in the direction away from the first bracket 321 along the first axial direction to form at least one groove 3213 that cooperates with the protrusion 3242. When the mounting surface of the second body 2 is parallel to the upper surface of the first body 1, the protrusion 3242 on the first position-limiting unit 324 can cooperate with the groove 3213 on the first bracket 321 to restrict the second body 2 at the current target position. When the second body 2 is subjected to a sufficiently large external force, the groove 3213 can be separated from the protrusion 3242 to facilitate the adjustment of the angle of the second body 2 relative to the first body 1.

The surface of the first position-limiting unit 324 on the side facing the first bracket 321 can also be recessed in the direction away from the first bracket 321 along the first axial direction to form at least one groove. The surface of the first bracket 321 on the side facing the first position-limiting unit 324 can also be extended outward in the direction toward the first bracket 321 along the first axial direction to form at least one protrusion that cooperates with the groove.

In some embodiments, a plurality of protrusions 3242 can be provided and arranged at different radial positions of the first position-limiting unit 324 to avoid being restricted when the first position-limiting unit 324 rotates to the interval angle of two protrusions relative to the first bracket 321.

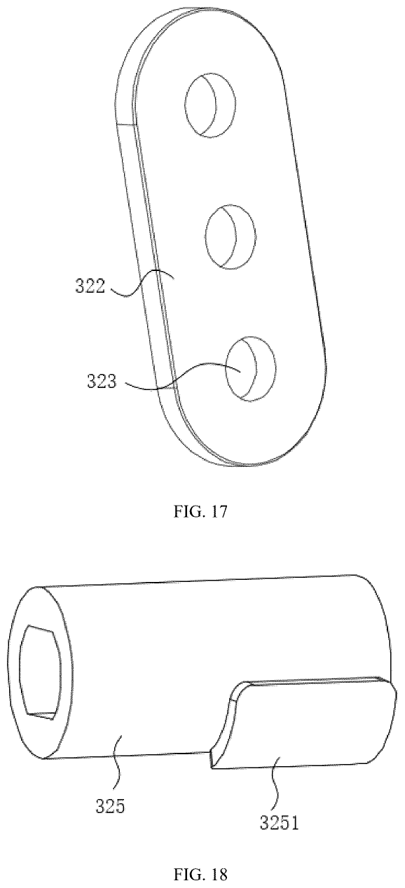

FIG. 17 is a schematic perspective diagram of a second position-limiting unit according to some embodiments of the present disclosure.

In some embodiments, as shown in FIG. 11 and FIG. 17, the supporting assembly 32 further includes a second position-limiting unit 325. The second position-limiting unit 325 is mounted on the first rotation shaft 31 and is located on the side of the bracket of the first rotation shaft 31 opposite to the first position-limiting unit 324. As shown in FIG. 16, the side of the bracket of the first rotation shaft 31 facing the second position-limiting unit 325 extends toward the second position-limiting unit 325 along the first axial direction to form a blocking arm 3211. The second position-limiting unit 325 can be configured to abut against the blocking arm 3211 when the plane where the mounting surface of the second body 2 lies is parallel to the upper surface of the first body 1, to prevent the second body 2 from further rotating toward the upper surface of the first body 1.

In some embodiments, as shown in FIG. 17, the second position-limiting unit 325 extends radially outward to form a blocking protrusion 3251. When the plane where the mounting surface of the second body 2 lies is parallel to the upper surface of the first body 1, the blocking protrusion 3251 can abut against the blocking arm 3211 to prevent the second body 2 from further rotating toward the first body 1.

In some embodiments, the second position-limiting unit 325 can be configured in a cylindrical shape.

In some embodiments, at least a portion of the first rotation shaft 31 in the axial direction can be a third mounting section. The cross-section of the third mounting section can be non-circular (e.g., D-shaped or rectangular). The through-hole on the axis of the second position-limiting unit 325 and the through-hole 3241 on the first position-limiting unit 324 can match the shape of the cross-sectional of the third mounting section to allow the first position-limiting unit 324 and the second position-limiting unit 325 to rotate with the first rotation shaft 31. The third mounting section can also extend to the second extension section or even to the first mounting section.

FIG. 18 is a schematic perspective diagram of a second bracket according to some embodiments of the present disclosure.

In some embodiments, as shown in FIG. 18, a plurality of mounting holes 323 are formed on the second bracket 322 of the two brackets. The first rotation shaft 31, the second rotation shaft 33, and the reversing shaft 341 pass through the mounting holes 323 to be mounted to the first bracket 321. The first rotation shaft 31, the second rotation shaft 33, and the reversing shaft 341 can also rotate within the plurality of mounting holes 323.

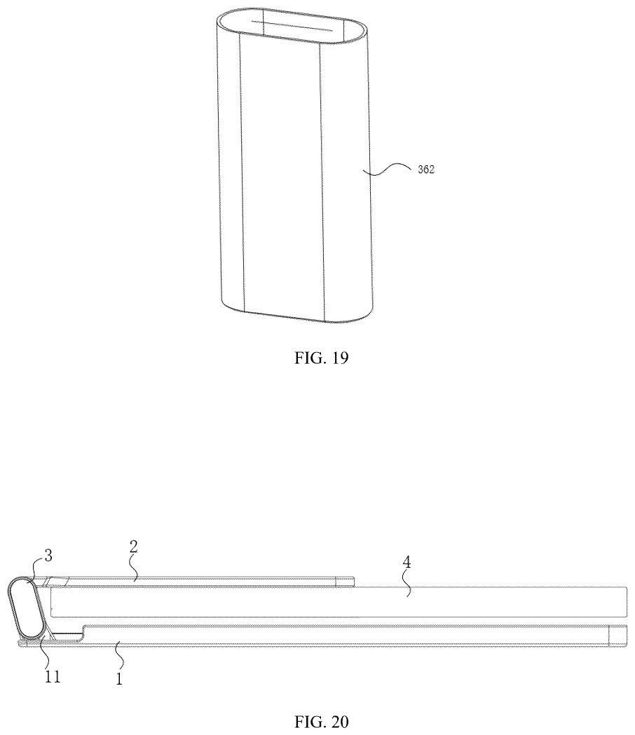

FIG. 19 is a schematic perspective diagram of a shell according to some embodiments of the present disclosure.

In some embodiments, as shown in FIGS. 9 and 19, the transmission mechanism 3 also includes a shell body 36. An accommodation space is formed inside the shell body 36. The accommodation space can be configured to mount the first rotation shaft 31, the second rotation shaft 33, the support assembly 32, and the reversing assembly 34.

In some embodiments, the shell body 36 can include an end cover 361 and a body member 362. The end cover 361 can pass through the first rotation shaft 31 and the second rotation shaft 33 to be mounted at an end of the first rotation shaft 31 and the second rotation shaft 33 close to the shaft base 11. The body member 362 can be in a cylindrical shape with an opening facing the end cover to cooperate with the end cover 361 to form the accommodation space.

In some embodiments, the bracket close to the end of the body member 362 (e.g., the first bracket 321 or the second bracket 322) can extend toward the end of the shell body in a direction parallel to the axial direction of the reversing shaft 341 to form an extension member. A through-hole can be formed on the end of the body member 362. A fixing part (e.g., a screw) can pass through the through-hole to threadedly cooperate with the extension member to mount the body member 362 on the bracket.

In some embodiments, two opposite side walls of the body member 362 can extend toward the directions toward each other to form a snap member. As shown in FIG. 10, a cooperation member configured to snap with the snap member is formed on the end of the end cover 361 close to the body member. Thus, when the body member 362 is mounted at the end cover 361, the body member 362 can be preliminarily fixed to prevent the body member 362 from falling.

In some embodiments, the bracket close to the end of the body member 362 can be the first bracket. As shown in FIGS. 15 and 16, an extension member 3212 is formed on the first bracket by extending in a direction parallel to the axial direction of the reversing shaft 341 toward the end of the shell body. The fixing part 363 passes through the through-hole on the body member 362 to mount the body member 362 at the first bracket 321.

In some embodiments, two transmission mechanisms 3 can be provided and can be located on two ends of the first edge of the second body 2, respectively. The number of transmission mechanisms 3 can be set as needed, for example, 1, 3, or 4.

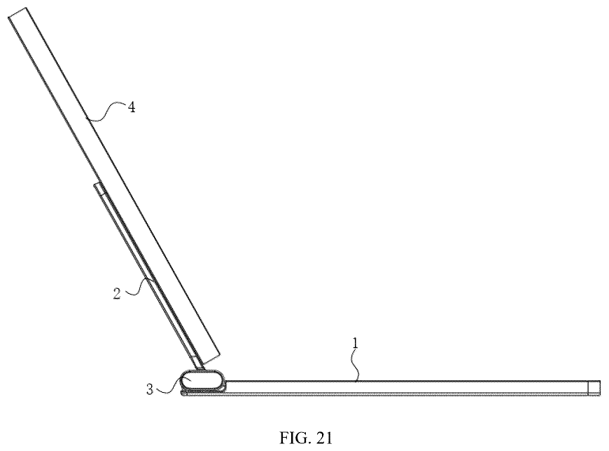

FIG. 20 is a schematic perspective diagram showing a status of an electronic device 4 mounted at a support apparatus according to some embodiments of the present disclosure. FIG. 21 is a schematic perspective diagram of another status of the electronic device 4 mounted at a support apparatus according to some embodiments of the present disclosure.

As shown in FIGS. 20 and 21, the external electronic device 4 is mounted on the second body 2 in a magnetic adsorption manner.

In some embodiments, a groove with an opening facing upward can be formed on the first edge of the second body 2. The electronic device 4 can be mounted and supported in the groove. The electronic device 4 can also be mounted on the second body 2 in other manners, such as a snap connection.

In some embodiments, the electronic device 4 can include a mobile phone or a tablet computer.

Embodiments of the present disclosure have been described above. However, these embodiments are merely for illustrative purposes and are not intended to limit the scope of the present disclosure. Although embodiments are described separately above, it does not mean that the measures of the above embodiment cannot be beneficially combined. The scope of the present disclosure is defined by the appended claims and their equivalents. Without departing from the scope of the present disclosure, various substitutions and modifications can be made by those skilled in the art. These substitutions and modifications can be within the scope of the present disclosure.

What is claimed is:

1. A support apparatus comprising:
a first body having a first mass greater than a threshold;
a second body configured to carry an external electronic device; and
a transmission mechanism connecting a first edge of the second body and the first body, based on the transmission mechanism, the second body being rotatable relative to the first body;
wherein:
in response to the second body having a first angle relative to the first body, the transmission mechanism is in a first state, and in response to the second body having a second angle greater than the first angle relative to the first body, the transmission mechanism is in a second state; and
in response to the transmission mechanism being in the first state, a first reference point on the first edge and a center of gravity of the first body have a first distance, in response to the transmission mechanism being in the second state, the first reference point on the first edge and the center of gravity of the first body have a second distance, and the first distance is greater than the second distance.

2. The support apparatus according to claim 1, wherein:
the transmission mechanism includes a rotation shaft;
in response to the transmission mechanism being in the first state, the rotation shaft is in a first position state, and in response to the transmission mechanism being in the second state, the rotation shaft is in a second position state; and
in the first position state, the rotation shaft has a third distance from a plane where the first body is, in the second position state, the rotation shaft has a fourth distance from the plane where the first body is, and the fourth distance is less than the third distance.

3. The support apparatus according to claim 2, wherein:
the transmission mechanism includes a first rotation shaft and a second rotation shaft, and a first axis of the first rotation shaft is parallel to a second axis of the second rotation shaft;
the second body performs a first rotation around the first axis in a first direction relative to the transmission mechanism to allow the second body to perform a second rotation with the transmission mechanism around a second axis in a second direction opposite to the first direction relative to the first body to move from the first state to the second state.

4. The support apparatus according to claim 3, wherein the transmission mechanism further includes:
a support assembly configured to be rotatably mounted between the first rotation shaft and the second rotation shaft; and
a reversing assembly rotatably mounted on the support assembly and configured to convert the first rotation of the first rotation shaft around the first axis in the first direction relative to the support assembly into the second rotation of the second body with the support assembly around the second axis in the second direction relative to the first body.

5. The support apparatus according to claim 4, wherein:
the first rotation shaft includes a first gear sleeve, and the second rotation shaft includes a second gear sleeve; and
the reversing assembly includes:
a reversing shaft mounted in parallel between the first rotation shaft and the second rotation shaft through the support assembly; and
a gear sleeve set arranged on the reversing shaft and meshing with the first gear sleeve and the second gear sleeve to convert the first rotation into the second rotation.

6. The support apparatus according to claim 5, wherein the gear sleeve set includes:
a first reversing gear sleeve meshing with the first gear sleeve; and
a second reversing gear sleeve meshing with the second gear sleeve to convert the first rotation into the second rotation.

7. The support apparatus according to claim 5, wherein:
a number of teeth of the first reversing gear sleeve is greater than a number of teeth of the second reversing gear sleeve;
the number of teeth of the first reversing gear sleeve is greater than a number of teeth of the first gear sleeve; and/or
a number of teeth of the second gear sleeve is greater than the number of teeth of the second reversing gear sleeve.

8. The support apparatus according to claim 4, wherein:
the support assembly includes two brackets arranged in a direction in parallel to a first axial direction at an interval;
mounting holes are formed on each of the two brackets in a direction perpendicular to the first axial direction at intervals; and
the first rotation shaft, the second rotation shaft, and the reversing shaft pass through the mounting holes to be mounted at the two brackets.

9. The support apparatus according to claim 8, wherein the transmission mechanism further includes:
a damping assembly mounted on at least one of the first rotation shaft and the second rotation shaft and configured to cooperate with the support assembly to restrict the second body in a target posture.

10. The support apparatus according to claim 9, wherein the support assembly further includes:
a first position-limiting unit mounted on the first rotation shaft, neighboring to the first bracket of the two brackets, and configured to, in response to a mounting surface of the second body being parallel to an upper surface of the first body, cooperate with the first bracket to restrict the second body in the target posture.
